(19) United States
(12) Patent Application Publication
(10) Pub. No.: US 2014/0193195 A1
(43) Pub. Date: Jul. 10, 2014

(54) Toothing for operation at a deflection angle and production method

(71) Applicant: Jurgen Merz, Kreuztal (DE)

(72) Inventor: Jurgen Merz, Kreuztal (DE)

(73) Assignee: SMS SIEMAG AG, Duesseldorf (DE)

(21) Appl. No.: 14/128,892

(22) PCT Filed: Jun. 22, 2012
(86) PCT No.: PCT/EP2012/062160

§ 371 Date: Mar. 12, 2014

(30) Foreign Application Priority Data
Jun. 24, 2011 (DE) 10 2011 078 071.8
Jul. 29, 2011 (DE) 10 2011 080 130.8

(51) Int. Cl. F16D 1/02; B23P 15/00

(52) U.S. Cl. CPC F16D 1/02; B23P 15/00
USPC 403/359.6; 29/592

(57) ABSTRACT

The invention relates to a toothing, in particular of a drive spindle for driving a roll in rolling mills or continuous casting plants, which comprises several teeth and meshes with a second toothing in the manner of a spline, wherein a flank line of the teeth has a curvature and a deflection angle is formed between the rotational axis of the second toothing and the rotational axis of the toothing, wherein the toothing (1) is designed as having at least one of the following modifications: a tooth root relief of the teeth (2), and/or a tooth tip relief of the teeth (2), and/or a twist of the teeth (2).

### 1. FIELD OF THE INVENTION

The present invention relates to the field of toothings and, in particular, to a drive spindle for driving a roll in a rolling mill or a continuous casting installation. The invention relates to a toothing according to the preamble of claim 1 and a production method for such toothing.

### 2. STATE-OF-THE-ART

In known applications, force transmission from a drive to a shaft at an angle is required. This requirement often arises, e.g., in rolling mills. E.g., if two working rolls are arranged one above the other, then, because of their relative small diameters, a problem arises when an increase of the transmitted torque is desired. If the transmitted torque increases, the working roll diameters need also be increased which, among others, leads to the energy losses. In addition, in this case, the rolling mill stand should be formed more strongly.

Therefore, the existing systems includes universal joints arranged between the drive spindle and the roll, however, the requirements of an increased torque transmission are still not met.

If splines are used for arranging the drive spindle at an angle to the roll, the drive spindle can be formed so that it is able to transmit a greater rolling mill torque, nevertheless, classical toothings, which are conventionally used in drive spindles, lead to edge loading which causes a very high wear and, as a result of which, no transmission of a desired high torque is possible.

The object of the invention is to be able to provide, between a toothing and a complementary second toothing, a deflection angle with which a greater torque can be transmitted than was the case up to now.

According to the invention, this object is achieved for the above-mentioned toothing by features of the characterized clause of claim 1.

If at least one modification takes place, the toothing can be driven at a deflection angle relative to the second toothing and can transmit a greater torque than was the case without the modification. In particular, the undertaken modification reduces the edge loading and provides for the increased torque transmission. Advantageously, two or more modifications can be combined, e.g., relief of both the tooth root and the tooth tip or a twist with one or two relieves.

Within the meaning of the invention, the relief of the tooth root or the tooth tip means that the profile line falls back in comparison with the conventional profile and, in particular, in the contact region of the teeth flanks during normal operation.

Further, the invention permits to increase the torque transmitted from a drive spindle to a roll and/or to increase the deflection angle between the drive spindle and the roll. Without the above-discussed modification, the carrying section of the flank becomes smaller at an increased deflection angle that is greater than zero, so that with the increased deflection angle, less torque can be transmitted. With the inventive toothing, the load can be uniformly distributed over the tooth height. Thus, e.g., the drive spindle can transmit, in certain cases, a torque increased by 50%, whereby greater strip widths can be rolled. With a further increase of the transmittable torque, the working rolls even can be made smaller.

According to an advantageous embodiment of the toothing, the toothing is formed as an involute toothing, whereby the tooth roots and/or tooth tips can be advantageously, but not necessarily, relieved at least parabolically. The at least parabolic relief should be understood as a relief with which the profile difference between the theoretical flank of an involute toothing and the inventive relieved flank is a function of an increase of a roll-off path over the profile of the involute toothing at least with about second power. That is why the relief is advantageously substantially parabolic.

With the parabolic relief of the tooth root or tip, the edge loads can be reduced and, thereby, the torque transmission can be improved.

In a further advantageous embodiment of the toothing, the tooth roots are relieved at a root circle by from 0.2% to 3% of a tooth thickness at a pitch circle, and/or the tooth tips are relieved at a tip circle by 0.1% to 2% of the tooth thickness at the pitch circle.

With these values of the profile modification of each tooth, the force transmission can be optimized during engagement of the toothings.

According to a further advantageous embodiment of the toothing, the tooth tip relief is provided between 50% and 70% of the tooth height and/or the tooth root relief is provided between 50% and 60% of the tooth height.

The above-mentioned values for the relief of the tip or root with respect to the tooth height permit to further optimize the transmittable torque.

In a still further advantageous embodiment of the toothing, an involute line of the teeth is symmetrically curved in a width direction. Under the involute line, as known, the bottom between two adjacent teeth is understood.

By forming a curved involute line, the torque transmission can be further increased. According to a yet further advantageous embodiment of the toothing, a curvature of the flank line is so formed that difference between a greatest thickness of each tooth at a height of the pitch circle and a smallest thickness of each tooth at the height of the pitch circle corresponds to a value between 3% and 20% of the greatest thickness of each tooth at the height of the pitch circle.

This feature makes advantageous profile of the curvature of the flank line more precise.

According to a further advantageous embodiment of the toothing, the twist of the teeth is formed by a maximal profile angle deviation between 0.3° and 1.5°.

This is a relatively small value of the twist noticeably improves the torque transmission during engagement of the toothing in the second toothing at an angle.

In another advantageous embodiment of the toothing, the twist of the teeth is formed substantially parabolic in direction of the tooth flank. This means that the profile deviation, as a function over the tooth width, has essentially a parabola-shaped profile.

The object of the invention for the above-mentioned production process for a toothing is achieved by features of claim 12.

Under the classical production, every mentioned below method, with which a basic shape of the toothing is produced as a result of reduction of the basic shape, e.g., milling and the like, is understood. The subsequent treatment for obtaining the inventive toothing can follow by grinding in a free-movable machine-tool, e.g., a 4-axes and 5-axes machine-tool.

In an advantageous embodiment of the method, a curved-back toothing is obtained, after production by a classical method as involute toothing, by the parabolic relief of the tooth root and/or the tooth tip by subsequent treatment.

In a further advantageous embodiment of the method, the after treatment is carried out by at least one of grinding process or by grinding each tooth blank.

The invention further includes a device for driving a roll of a metallurgical installation and including a shaft with a toothing according to one of the above-mentioned claims. Such a shaft can, e.g., be set in a corresponding opening in a roll and/or a motor in a manner of a spline toothing. The opening can be provided, in particular, with an inner toothing that can likewise be formed according to the invention. The inner toothing can be formed, in a possible embodiment, in which the shaft or the inventive toothing is displaceable by a predetermined stroke, as a spur toothing.

In an advantageous embodiment of the device, the toothing according to one of claims 1 through 7 is provided at both ends of the shaft. This provides an intermediate shaft that, e.g., is connectable at both end by an inclined spur toothing, and, thus, enables transmission of a particular large torque at a particular large angle or a predetermined angle.

In an advantageous embodiment, the shaft and the roll are arranged relative to each other at a deflection angle of more than 0°, in particular more than 0.2°. Particularly advantageously, the deflection angle does not exceed 3°, in particular, lies between 2° and about 3°.

### BRIEF DESCRIPTION OF THE DRAWINGS

Below, the drawings of the embodiments of the invention will be briefly described. Further details will become apparent from the detailed description of the embodiments.

The drawings show:

FIG. 1 a partial cross-section over the height of a tooth of an embodiment of the invention in which an inventive modification of a profile of the right flank of the tooth is shown, in particular of the tooth root and of the tooth tip;

FIG. 2 a schematic plan view of an inventive embodiment with a cross-sectional plane B-B;

FIG. 3 a plan view of the cross-section B-B in FIG. 2;

FIG. 4 a view of a detail in FIG. 3 with a schematic representation of an inventive modification of the flank line;

FIG. 5 a schematic diagram of an embodiment of the invention in case of a twist with changing profile of angle φ in angular units in the Z-direction, at arbitrary heights, extending in a width direction of the tooth;

FIG. 6 a partial elevational view of the inventive device for driving rolls of a metallurgical installation; and

FIG. 7 a view of a detail of the device of FIG. 6 at an increased scale.

### DETAILED DESCRIPTION OF THE PREFERRED EMBODIMENTS

It is to be noted that one of ordinary skill in the art is familiar with terms such as pitch circle, tip circle, root circle, surface line, flank line, pressure angle, twist and others and, therefore, they will be used in the following description without any further explanation.

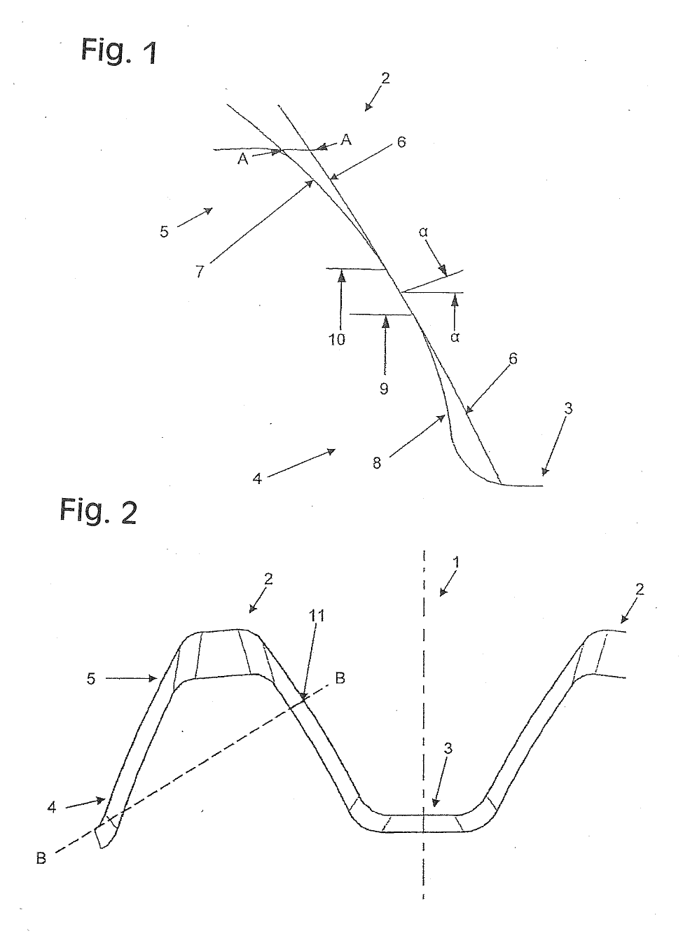

FIG. 1 schematically shows a cross-section of a flank of a tooth 2 of a toothing 1. The flank line is convexly bent, and therefore, basically, one can speak of a curved-back toothing. On the right of this flank, a tooth gap 3 is seen. The rotational axis of the toothing 1 extends perpendicular to the shown cross-sectional plane. The pressure angle α of the toothing can have different values, in particular, it can advantageously amount to values between 26° and 34°. The line 6 represents the profile line of the tooth 2 in form of a classical involute line 6 of a known involute toothing. Though, according to the invention, the root 4 and/or the tip 5 can assume, preferably, other forms ground with respect to a classical involute form. The relief of the tooth tip 5 is shown with line 7, and of the tooth root 4 with line 8. The relief of the tooth tip 5 at the tip circle is schematically shown by a path or spacing A-A. The radii or diameters, with which the relieves of the tooth root 4 and or of the tooth tip 5 are set, are shown with reference numerals 9, 10. Between the points 9 and 10, the profile of the flank of the tooth 2 corresponds, preferably, to an involute shape 6, however, it can be described by other conventional profiles. The tooth tip relief and the tooth root relief, which are shown in FIG. 1, are shown at a substantially increased scale, and they should be understood as only schematic. The same applies to radii 9 and 10. The tooth root relief can have different values, however, they amount, preferably, at the tooth circle, between 0.2% and 3% of the tooth thickness measured at the pitch circle, wherein the thickness direction extends transverse to the width direction of the toothing 1. The tooth tip 5 preferably has a relief from about 0.1% to 2%, at the tip circle or at the height of the tip circle, of the tooth thickness (measured at the pitch circle). The relief of the tooth tip 5 starts, preferably, between 50% and 70% of the tooth height, and/or of the tooth root 4 between 50% and 60% of the tooth height. The tooth height is defined as difference of radii of the tooth tip and the tooth root. In other words, it means that the tip and/or root relieves are set at radii which correspond to the above-mentioned percentage parameters of the difference between the tip and root circles radii.

FIG. 2 likewise shows a schematic cross-section of an inventive toothing 1, however, here, only the curvature or the modification of the involute line is emphasized. The view should be understood as two-dimensional. Only tooth 2 of the toothing 1 and a tooth gap 3 between the teeth are seen. The line at the upper end of the left tooth 2 represents the highest position in the width direction (direction of the rotational axis of the toothing or, in the future in Z-direction) of the involute line. The lower limiting line of the left tooth 2 represents the involute line at the edge of the toothing 1, as seen in the width direction. The curvature of the involute line is advantageously obtained by grinding a classically formed or produced toothing. However, other known manufacturing processes can be used. The curvature, preferably seen in the width direction, is mirror-symmetrical towards the middle of the toothing 1 and is curved particularly outwardly or is convex.

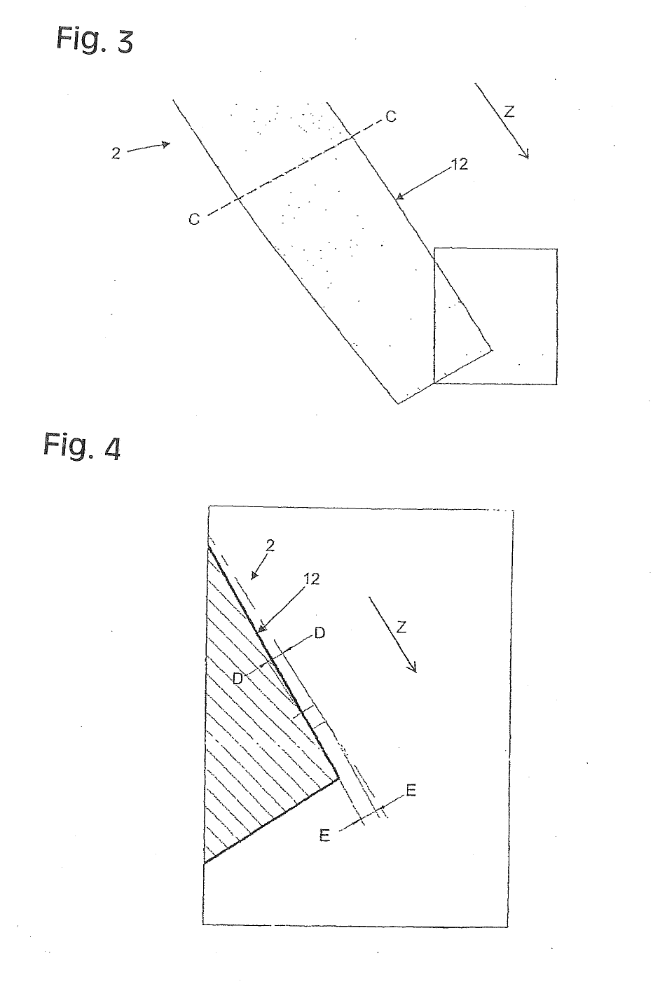

The line B-B in FIG. 2 defines a cross-sectional plane which is shown and clarified in FIG. 3. The cross-sectional plane B-B passes through the intersection of the pitch circle of the toothing 1 with the involute 6 of a tooth 2.

FIG. 3 shows a plan view of the flank line 12 of the right flank of the tooth 2. The line C-C shows half of the middle axis of the tooth 2 and that extends transverse to the width direction, i.e., in the thickness direction of the tooth 2. On the right side of FIG. 3, a rectangle is shown which represents a cut-out shown in FIG. 4.

FIG. 4 shows an end of the flank line 12 as seen in the width direction Z. The line D-D shows the relief of the flank line 12 at a first location. The flank line 12 is in particular, curved outwardly or is convex. The relief of the flank line 12 can be obtained preferably by grinding, however, other known processes can be used.

The flank line modification or the relief of the flank line 12 at the rim of the toothing 1 has a size of the line E-E, when seen in the width direction. The size in the drawing should be understood as purely schematic. The relief of the flank line at the rim of the toothing 1 in the width direction can advantageously amount to form 3% to 20% of the thickness of a tooth 2 of a spur toothing or from 3% to 20% of the thickness at the point of the maximum thickness of the tooth 2 at the height of the pitch circle.

Generally, the relief of the flank line in FIG. 4 is seen, in the width direction, at the rim of the toothing 1 but more pronounced that shown by the line E-E. Further, the shown relief, in this case, on the spur tooth 2, is produced by an optional twist, i.e., by twisting the tooth.

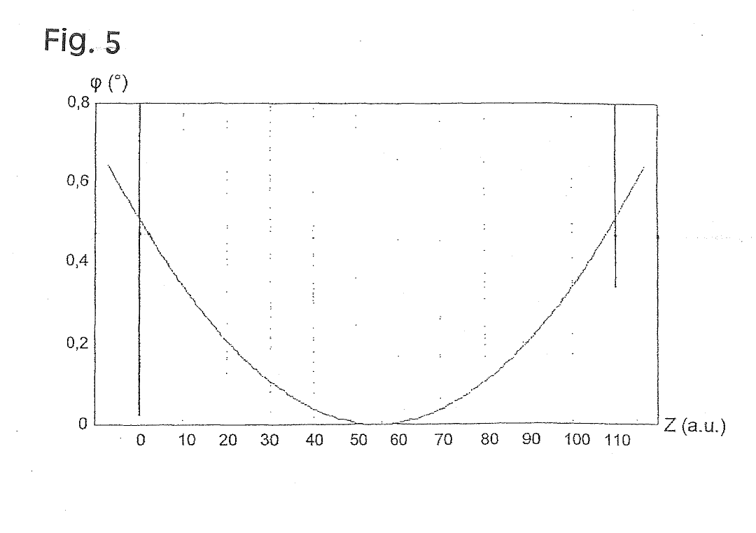

Such twisting of ht tooth can be described by changing the profile angle φ in the Z-direction or of the flank of the tooth 2. An example of such twisting is shown in diagram of FIG. 5.

FIG. 5 shows a parabolic profile of the twist in Z-direction. The profile angle deviation (φ) is shown in degrees with respect to the width of the toothing 1 in the Z-direction. The numbers in the Z-axis are given only as examples for a width of the toothing 1 up to 110, wherein the line unit represents an arbitrary length value. It can be seen that the profile angle deviation in the middle of the toothing 1 in the width direction equals almost zero and falls out at most at rims of the toothing 1. In this example, about 0.5° at the rim. However, other values of twists are possible such as, e.g., twists with a maximum deviation of the profile angle φ between 0.3° and 1.5°.

In summary, the above-mentioned figure values are valid for a deflection angle between the toothing 1 and a second toothing, preferably, an inner toothing, between 0° and 5° and particularly advantageous between 2° and 5°.

The second toothing can have its rotational axis lying directly on the axis of a roll. In addition, the second toothing can be directly integrated in the roll or lie in an attachment directly connected or connectable with the roll journal, wherein its rotational axis preferably coincides with that of a roll. As generally conventional, such an attachment connects the roll with the drive spindle.

The toothing 1 described with reference to different embodiments, is preferably a spur toothing, i.e., preferably is not cut obliquely. The same applies to the second toothing which is formed, e.g., by an inner toothing.

In particular, the toothing 1 can be provided in a drive spindle for driving a roll provided in a rolling mill of a continuous casting installation or of a strip processing line. The construction of such drive spindles is generally known. The toothing 1 can be formed as one piece with a drive spindle or be mounted on the drive spindle.

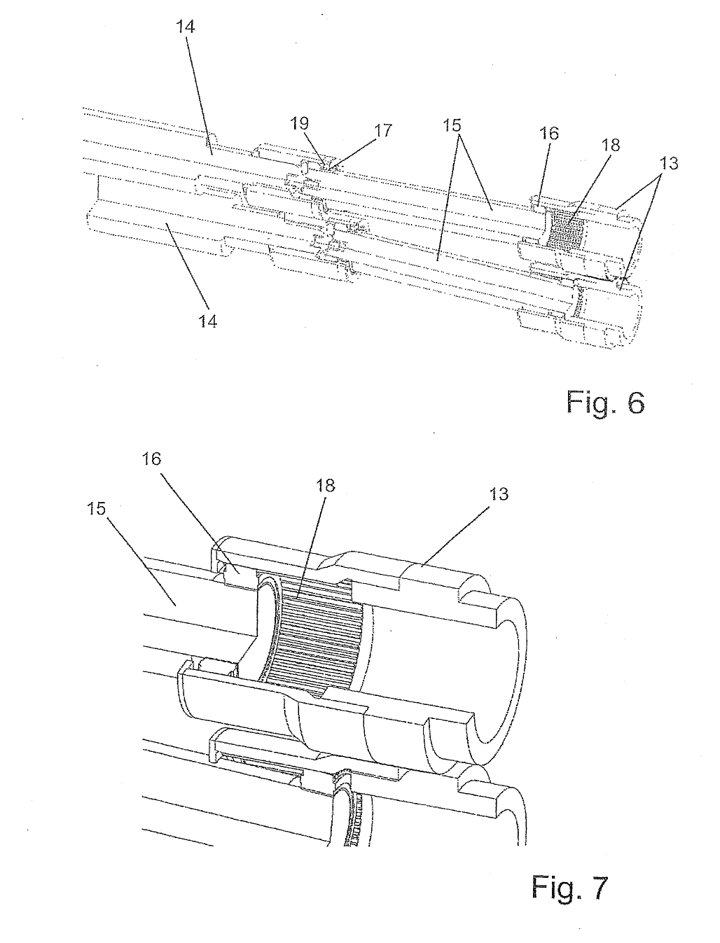

The device for driving two rolls 13 of a rolling mill, which is shown in FIG. 6, has, for each of the rolls 13, an output shaft (not shown) of a motor or motor drives 14, wherein an intermediate shaft 15 is arranged between the rolls 13 and the output shafts 14, respectively.

The intermediate shaft 15 has, at each of its ends, the inventive toothing 16, 17, respectively. The toothing 16 engages in an inner toothing 18 of the roll 13 in spline-like manner, and the other toothing 17 engages in the inner toothing 19 of the output shaft 14. The intermediate shaft 15 is arranged at an angle relative to the roll 13 and relative to the output shaft 14. Thereby, a noticeably greater distance of the output shafts 14 or the motors and/or drives from each other becomes possible, which corresponds to the distance between axes of the rolls 18.

The inner toothing 18 of the shaft 13 is formed as spur toothings, whereby in accordance with the requirements, the inventive spur toothing can be used, i.e., profile lines in the tip region and/or root region can be provided with a relief.

The inner toothing 18 enables displacement of the engaging toothings 16 of the intermediate shafts 15 in the axial direction by a maximum stroke, whereby per se known axial displacement of the rolls 13 during a rolling process is possible.

The above-mentioned features can be arbitrarily combined with each other. IN additional, one of ordinary skill in the art can change constructive particularities to a different shape.

### LIST OF REFERENCE NUMERAL

1 Toothing
2 Tooth
3 Tooth gap
4 Tooth root
5 Tooth tip
6 Involute
7 Outline of a relieved tooth tip
8 Outline of a relieved tooth root
9 Radius of the tooth root relieve
10 Radius of the tooth tip relief
11 Intersection of the pitch circle with involute
12 Flank line
13 Roll
14 Output shaft
15 Intermediate shaft
16 Toothing
17 Toothing
18 Inner toothing
19 Inner toothing
A-A Tooth tip relief at the tip circle
B-B Tooth cross-section
C-C Involute line of the toothing in direction of the tooth thickness
D-D First amount of the flank line relief
E-E Second amount of the flank line relief
α Engagement angle
φ Profile angle deviation
Z Width direction of the toothing

1-14. (canceled)

15. Spline toothing having a toothing (1) engaging in a second toothing, in particular of a drive spindle for driving a roll (13) in a rolling mill or a continuous casting installation, wherein the toothing (1) has many teeth (2), wherein a flank line (12) of the teeth (2) has a curvature and a deflection angle is formed between a rotational axis of the second toothing and a rotational axis of the toothing,
characterized in that:
the teeth (2) are formed with a twist in form of a profile angle deviation φ in direction of the flank of a tooth (2).

16. Spline toothing according to claim 15,
characterized in that
flanks of the teeth (2) are formed with a tooth tip profile relief with respect to an involute form.

17. Spline toothing according to claim 15,
characterized in that
flanks of the teeth (2) are formed with a tooth root profile relief with respect to an involute form.

18. Spline toothing according to claim 15,
characterized in that
a profile line of a tooth flank on a tooth root (4) and/or a tooth tip (5) is relieved at least parabolically, that a profile difference between a theoretical flank of the involute toothing and the relieved flank increases at least by second power as a function of a roll-off path over the profile of the involute toothing.

19. Spline toothing according to claim 18, wherein the tooth root (4) is relieved on the root circle between 0.2% and 3% of the tooth thickness on the pitch circle, and/or the tooth tip (5) is relieved on the tip circle between 0.1% and 2% of the tooth thickness on the pitch circle.

20. Spline toothing according to claim 15, wherein an involute line is symmetrically curved as a path of a bottom between two teeth in a width direction.

21. Spline toothing according to claim 15, wherein a curvature of the flank line (12) is so formed that difference between a greatest thickness of each tooth (2) at a height of the pitch circle and a smallest thickness of each tooth (2) at the height of the pitch circle corresponds to a value between 3% and 20% of the greatest thickness of each tooth (2w) at the height of the pitch circle.

22. Spline toothing according claim 15, wherein the twist of the teeth (2) is formed by a maximal profile angle deviation (φ) between 0.3° and 1.5°.

23. Spline toothing according to claim 15, wherein the twist of the teeth (2) is formed substantially parabolic in direction of the tooth flank.

24. Device for driving a roll of a metallurgical installation, comprising a shaft (15) with a toothing (16, 17, 18, 19) having engaging in a second toothing, in particular of a drive spindle for driving a roll (13) in a rolling mill or a continuous casting installation, wherein the toothing (1) has many teeth (2), wherein a flank line (12) of the teeth (2) has a curvature and a deflection angle is formed between a rotational axis of the second toothing and a rotational axis of the toothing,
characterized in that:
the teeth (2) are formed with a twist in form of a profile angle deviation φ in direction of the flank of a tooth (2), wherein the shaft (15) includes the toothing (16, 17) of the spline toothing (16, 17, 18, 19).

25. Device according to claim 24,
characterized in that
the toothing (16, 17) is provided at both ends of the shaft (15).

26. Device according to claim 24, characterized in that the shaft (15) and a roll (13) are arranged at an angle greater than 0°, in particular, more than 0.2° to each other.

27. Device according to claim 26, characterized in that the deflection angle amount to no more than 5°, in particular, between about 2° and about 5°.

28. Method of producing a spline toothing having a toothing (1) engageable in a second toothing wherein the toothing (1) has many teeth (2), wherein a flank line (12) of the teeth (2) has a curvature and a deflection angle is formed between a rotational axis of the second toothing and a rotational axis of the toothing,
characterized in that:
the teeth (2) are formed with a twist in form of a profile angle deviation φ in direction of the flank of a tooth (2), including the step:
producing the toothing (1) with a plurality of teeth,
characterized in that
the following steps of after-treatment are carried out on the produced toothing so that a rotational axis of the toothing (1) can be driven at a deflection angle to a rotational axis of the second toothing:
treating flank lines (12) of the toothing (1) so that those have a curvature;
treating the teeth (2) so that they are formed with a twist in form a profile angle deviation φ in direction of the flank of the tooth (2).

29. Method according to claim 28,
characterized in that
the after-treatment includes additionally the following step:
treating the flanks of tooth tips of the teeth (2) so that they are relieved with respect to an involute profile.

30. Method according to claims 28,
characterized in that
the after-treatment includes additionally the following step:
treating the flanks of tooth roots of the teeth (2) so that they are relieved with respect to an involute profile.

31. Method according to claim 28,
wherein a profile line of the tooth root (4) and/or the tooth tip (5) is so relieved at least parabolically by after-treatment that a profile difference between the theoretical flank of an involute toothing and the relieved flank according to the invention, increases at least by second power as a function of a roll-off path over the profile of the involute toothing.

32. Method according to claim 28,
characterized in that
the after-treatment includes additionally the following step:
treating the involute line of the toothing (1) as a path of the bottom between two teeth so that the involute line has a curvature in a width direction.

33. Method according to claim 28,
characterized in that
the after-treatment is carried out in at least one of the steps by at least one grinding process or by grinding each tooth flank.
